(19) United States
(12) Patent Application Publication
(10) Pub. No.: US 2016/0195923 A1
(43) Pub. Date: Jul. 7, 2016

(54) Gyroscopic chair for virtual reality simulation

(71) Applicant: Krush Technologies, LLC, Dayton, OH (US)

(72) Inventors: John P. Nauseef, Kettering, OH (US); Christoper S. Wire, Dayton, OH (US); Dustin L. Clinard, Dayton, OH (US); Marc C. Stevens, Kettering, OH (US); Bryan S. Campbell, Dayton, OH (US); Joseph H. Althaus, Yellow Springs, OH (US)

(73) Assignee: Krush Technologies, LLC, Dayton, OH (US)

(21) Appl. No.: 14/980,827

(22) Filed: Dec. 28, 2015

Related U.S. Application Data
(60) Provisional application No. 62/096,989, filed on Dec. 26, 2014.

(51) Int. Cl. G06F 3/01; G06F 3/16; A47C 1/032; G06T 19/00; H04N 5/222; A47C 1/00; H04L 29/06; G06F 3/0346

(52) U.S. Cl. CPC G06F 3/012; H04L 67/42; G06F 3/167; G06F 3/017; G06F 3/0346; G06T 19/006; H04N 5/2224; A47C 1/00; A47C 1/032

(57) ABSTRACT

Embodiments disclosed herein may be directed to a gyroscopic chair comprising: a frame; a suspended ring coupled to the frame; a platform coupled to the suspended ring and configured to receive a user; and at least one motor coupled to at least one of the frame, the suspended ring, and the platform, wherein the at least one motor is configured to control movement of at least one of the frame, the suspended ring, and the platform.

### CROSS REFERENCE TO RELATED APPLICATION

This application is a nonprovisional application of, and claims priority to, U.S. Provisional Patent Application No. 62/096,989 filed on Dec. 26, 2014, the disclosure of which is hereby incorporated by reference in its entirety.

### TECHNICAL FIELD

Embodiments disclosed herein relate to a gyroscopic chair for virtual reality simulation.

### BACKGROUND

Today, virtual reality technologies provide sensual immersion into a digital environment like never before. For example, a person may wear a head-mounted audio-visual display that completely immerses the person into a virtual world. The person may control an avatar in the virtual world based on corresponding physical actions performed by the person, such as the person moving her or his head. However, physical effects of the avatar's movements in the virtual world often translate poorly to the person's real world experience, particularly with respect to enabling the user to experience physical forces such as gravity, acceleration, deceleration, and/or the like associated with various actions performed in the virtual reality environment. As such, there is great opportunity for development of enhancements to be applied to virtual reality technologies.

### SUMMARY

Briefly, aspects of the present invention relate to enhancements of virtual reality simulation experiences through the use of a gyroscopic chair and/or audio-visual processing techniques described herein. In some embodiments, a gyroscopic chair is provided. The gyroscopic chair may comprise: a frame; a suspended ring coupled to the frame; a platform coupled to the suspended ring and configured to receive a user; and at least one motor coupled to at least one of the frame, the suspended ring, and the platform, wherein the at least one motor is configured to control movement of at least one of the frame, the suspended ring, and the platform.

In some embodiments, the frame is coupled to a base, and wherein the at least one motor is configured to rotate the frame on a yaw axis with respect to the platform.

In some embodiments, the at least one motor is configured to rotate the suspended ring on a roll axis with respect to the platform.

In some embodiments, the at least one motor is configured to rotate the platform on a pitch axis with respect to the suspended ring.

In some embodiments, the at least one motor is configured to control movement of at least one of the frame, the suspended ring, and the platform based on movement data received from a control server associated with a virtual reality simulation application.

In some embodiments, the movement data is generated by the control server based at least in part on video content associated with the virtual reality simulation application and sensor data received from at least one of a head-mounted display, an acoustic feedback device, and a user input device.

In some embodiments, the sensor data is associated with at least one of a head movement, a facial gesture, a spoken keyword, a vocal inflection, and a user input.

In some embodiments, a video communication sever is provided. The control server may comprise: at least one memory comprising instructions; and at least one processing device configured for executing the instructions, wherein the instructions cause the at least one processing device to perform the operations of: receiving, using a content management unit comprised in the at least one processing device, video content associated with a virtual reality simulation application; receiving, using at least one of a head orientation unit comprised in the at least one processing device, an audio processing unit comprised in the at least one processing device, and a user feedback unit comprised in the at least one processing device sensor data from at least one of a head-mounted display, an acoustic feedback device, and a user input device; identifying, using a platform control unit comprised in the at least one processing device, movement data associated with at least one motor movement to be performed by at least one motor of the gyroscopic chair based at least in part on the video content and the received sensor data; transmitting, using the platform control unit, the movement data to the at least one motor of the gyroscopic chair.

In some embodiments, transmitting the movement data to the at least one motor of the gyroscopic chair causes the at least one motor to perform at least one movement, wherein performing the at least one movement causes at least one element of the gyroscopic chair to move.

In some embodiments, the at least one element of the gyroscopic chair comprises at least one of a frame, a suspended ring, and a platform configured to receive a user.

In some embodiments, the sensor data is associated with at least one of a head movement, a facial gesture, a spoken keyword, a vocal inflection, a vocal pitch shift, and a change in word delivery speed.

In some embodiments, the head movement is identified by: receiving, from the head-mounted display and using the head orientation unit, sensor data associated with the head-mounted display; identifying, using the head orientation unit, a first location and a first orientation of the head-mounted display at a first time; identifying, using the head orientation unit, a second location and a second orientation of the head-mounted display a second time; and identifying the head movement based at least in part on a comparison between the identified location and orientation of the head-mounted display at the first time and the identified location and orientation of the head-mounted display at the second time.

In some embodiments, the facial gesture is identified by: receiving, from the head-mounted display and using the head orientation unit, a live video feed of a face of a user of the head-mounted display; identifying, in the live video feed and using the head orientation unit, a first location of at least one facial feature of a user of the head-mounted display at a first time; identifying, in the live video feed and using the head orientation unit, a second location of the at least one facial feature of the user at a second time; and determining, using the head orientation unit, movement of the facial feature from the first location at a first time to the second location at a second time, wherein the determined movement of the facial feature comprises the facial gesture, and wherein the facial gesture is associated with a determined emotion.

In some embodiments, the vocal inflection is identified by: receiving, from the head-mounted display and using the audio processing unit, a live audio feed of speech of a user of the head-mounted display; identifying, in the live audio feed and using the audio processing unit, a first vocal pitch of speech of the user at a first time; identifying, in the live audio feed and using the audio processing unit, a second vocal pitch of speech of the user at a second time; and determining, using the audio processing unit, a change of vocal pitch of speech of the first user, wherein the determined change of vocal pitch is associated with a determined emotion.

In some embodiments, a method is provided. The method may comprise: receiving, using a content management unit comprised in at least one processing device, video content associated with a virtual reality simulation application; receiving, using at least one of a head orientation unit comprised in the at least one processing device, an audio processing unit comprised in the at least one processing device, and a user feedback unit comprised in the at least one processing device sensor data from at least one of a head-mounted display, an acoustic feedback device, and a user input device; identifying, using a platform control unit comprised in the at least one processing device, movement data associated with at least one motor movement to be performed by at least one motor of the gyroscopic chair based at least in part on the video content and the received sensor data; transmitting, using the platform control unit, the movement data to the at least one motor of the gyroscopic chair.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 shows an exemplary system environment, in accordance with some embodiments of the disclosure;

FIG. 2 shows an exemplary gyroscopic chair, in accordance with some embodiments of the disclosure;

FIG. 3 shows an exemplary computing environment, in accordance with some embodiments of the disclosure;

FIG. 4 shows an exemplary method of performing operations associated with controlling motor movement of a gyroscopic chair based on a detected head movement, in accordance with some embodiments of the disclosure;

FIG. 5 shows an exemplary method of performing operations associated with controlling motor movement of a gyroscopic chair based on a detected emotion of a user, in accordance with some embodiments of the disclosure;

FIG. 6 shows an exemplary method of performing operations associated with controlling motor movement of a gyroscopic chair based on a detected keyword, in accordance with some embodiments of the disclosure; and

FIG. 7 shows an exemplary method of performing operations associated with controlling motor movement of a gyroscopic chair based on a received user input, in accordance with some embodiments of the disclosure;, in accordance with some embodiments of the disclosure.

### DETAILED DESCRIPTION

### Introduction

Embodiments of the present disclosure may be directed to a system that includes a gyroscopic chair that enhances a user's virtual reality simulation experience. For example, the gyroscopic chair may enable the user to better experience physical forces corresponding to actions being performed by an avatar in a virtual world. In this manner, the gyroscopic chair may provide the user with a more immersive virtual reality simulation experience.

In addition to providing a gyroscopic chair, the system may enable real-time analysis of sensor data associated with user movements during operation of a virtual reality simulation application. For example, the system may receive streams of sensor data associated with movements of the user's head and/or facial features, as well as movements provided by the user via a user input device (e.g., a physical controller). Based on analysis of sensor data, the system may enable the gyroscopic chair to respond more accurately to user movements and/or the corresponding virtual reality simulation experience.

### System Environment

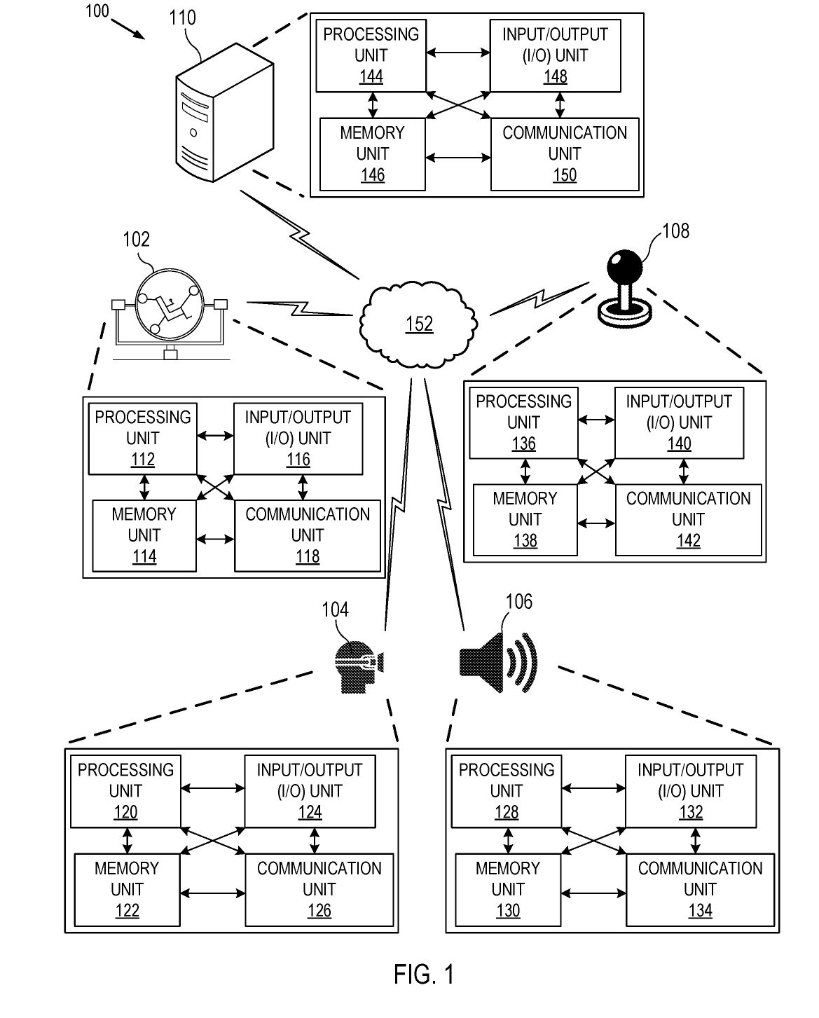

Referring now to the Figures, FIG. 1 illustrates an exemplary system 100 for enhancing a virtual reality simulation experience as described herein. In some embodiments, the system 100 may include a gyroscopic chair 102, a head-mounted display 104, an acoustic feedback device 106, a user input device 108, and/or a control server 110.

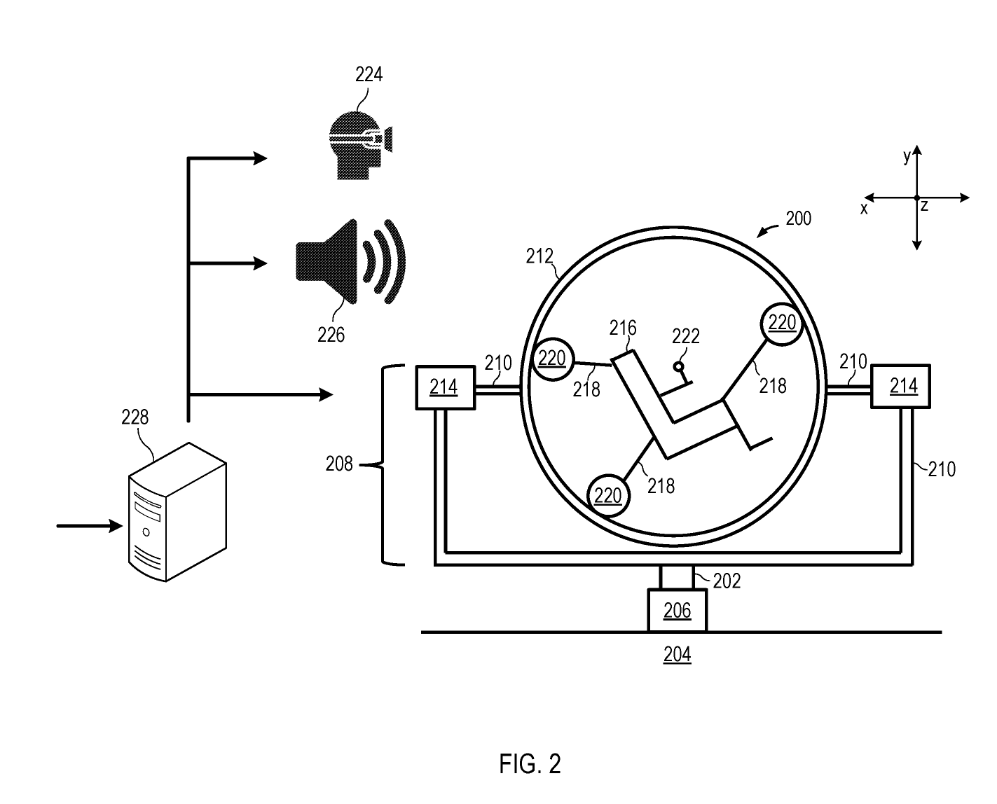

As described in more detail below with reference to FIG. 2, the gyroscopic chair 102 may receive a user of a virtual reality simulation experience. For example, the gyroscopic chair 102 may include a seat, a chair, a platform, a cage, a harness, a cabin, a capsule, a restraint, and/or the like configured to receive and securely contain the user during its operation. During operation, the gyroscopic chair 102 may be configured to rotate, tilt, lean, swing, sway, flip, and/or otherwise move the user in response to various stimulants and/or inputs provided by the user, movements of the user, and/or content associated with a virtual reality simulation application. To facilitate movement of the user in many directions and/or on multiple axes, the gyroscopic chair 102 may include one or more computing elements and/or motors for controlling elements of the gyroscopic chair 102.

For example, a first motor may enable rotation of the gyroscopic chair 102 on a first axis, whereas a second motor may enable rotation of the gyroscopic chair 102 on a second axis. In this manner, the gyroscopic chair 102 may enable the user to experience various movements that correspond to physical forces experienced in the virtual reality simulation experience. The gyroscopic chair 102 may further include one or more sensors for detecting movements and/or motions performed by various elements of the gyroscopic chair, as well as for detecting intensity, length, duration, speed, and/or any other factor associated with performed movements and/or motions. Further, the control server 110 may be configured to process the received sensor data as it applies to instantaneous user impressions (e.g., emotions, visual focus, physical reaction, and/or the like) of portions of the visible display/head-mounted display 104 so as to determine further gameplay elements based upon the detected user impressions. For example, the user may tilt her or his head backward in a surprised response to video content being presented to the user via the head-mounted display 104, thereby generating sensor data associated with the head tilt. Accordingly, the control server 110 may, based on an analysis of the sensor data, determine one or more actions to be performed by one or more motors of the gyroscopic chair 102 so that the gyroscopic chair 102 moves the user in a way that provides the user with a physical and/or physiological sensation that realistically corresponds to the head tilt. Additionally, the control server 110 may, based on the analysis of the sensor data, determine video content to be presented to the user via the head-mounted display 104 and/or audio content to be presented to the user via the acoustic feedback device 106 that that realistically corresponds to the head tilt. In this manner, the control server 110 may enhance the experience of the user by providing relevant content and/or movement of the gyroscopic chair 102 in response to received sensor data associated with the user's movements.

In some embodiments, the gyroscopic chair 102 may include various elements of a computing environment as described herein. For example, the gyroscopic chair 102 may include a processing unit 112, a memory unit 114, an input/output (I/O) unit 116, and/or a communication unit 118. Each of the processing unit 112, the memory unit 114, the input/output (I/O) unit 116, and/or the communication unit 118 may include one or more subunits as described herein for performing operations associated with providing an enhanced virtual reality simulation experience as described herein.

The head-mounted display 104 may include a visor, a helmet, glasses, goggles, and/or another wearable device that provides the user with a visual virtual reality experience. For example, the head-mounted display 104 may include a visual display such as a screen, a light-emitting diode (LED) array, and/or the like that provides to the user visual images associated with the virtual reality simulation experience. In some embodiments, the visual display may be oriented toward the user's eyes so that when the user wears the head-mounted display 104, the visual display is providing an image to the user's eyes. In some embodiments, the visual display of the head-mounted display 104 may wrap partially around the user's head. Alternatively, the visual display of the head-mounted display 104 may completely surround the user's head (or at least the user's line of vision) so that the user is only enabled to see the image being provided to the user via the visual display. In this manner, the head-mounted display 104 may provide a completely immersive visual experience to the user.

The head-mounted display 104 may further include one or more sensors for capturing data associated with user movements. For example, the head-mounted display 104 may include a gyroscope, an accelerometer, a biometric sensor, and/or another sensing device for detecting head movements of the user such as a head tilt, a head turn, and/or other movements. Information collected by these sensors may be used to enhance the user's virtual reality simulation experience as described herein.

Additionally, the head-mounted display 104 may include one or more cameras for capturing images of a user's face to detect facial features, as well as facial feature movements. For example, the head-mounted display 104 may include a camera that identifies a smile of the user, eye movements, and/or the like. This facial feature movement information collected by sensors and/or cameras of the head-mounted display 104 may enable identification of the user's emotions and may be utilized to enhance the virtual reality simulation experience as described herein.

In some embodiments, the head-mounted display 104 may include various elements of a computing environment as described herein. For example, the head-mounted display 104 may include a processing unit 120, a memory unit 122, an input/output (I/O) unit 124, and/or a communication unit 126. Each of the processing unit 120, the memory unit 122, the input/output (I/O) unit 124, and/or the communication unit 126 may include one or more subunits as described herein for performing operations associated with providing an enhanced virtual reality simulation experience as described herein.

The acoustic feedback device 106 may provide the user with an auditory image (e.g., speech, environment sounds, sound effects, music, and/or other audio signals). The acoustic feedback device 106 may include one or more input devices and/or one or more output devices such as microphone, a speaker, a subwoofer, and/or the like. In some embodiments, the acoustic feedback device 106 may be included in and/or otherwise incorporated into (e.g., coupled with) the gyroscopic chair 102 and/or the head-mounted display 104. The acoustic feedback device 106 may further include an array of speakers, drivers, tweeters, woofers, and/or the like configured to provide an immersive surround sound experience. In some embodiments, the acoustic feedback device 106 may include one or more sensors for measuring output (e.g., decibel level, direction, intensity, and/or the like) of various sounds as described herein.

In some embodiments, the acoustic feedback device 106 may include various elements of a computing environment as described herein. For example, the acoustic feedback device 106 may include a processing unit 128, a memory unit 130, an input/output (I/O) unit 132, and/or a communication unit 134. Each of the processing unit 128, the memory unit 130, the input/output (I/O) unit 132, and/or the communication unit 134 may include one or more subunits as described herein for performing operations associated with providing an enhanced virtual reality simulation experience as described herein.

The user input device 108 may embody a physical controller that enables the user to control one or more aspects of the virtual reality simulation experience. For example, the user may utilize the user input device 108 to control movement of an avatar (e.g., the user) in the virtual reality simulation experience. In some embodiments, the user input device 108 may include a joystick, a steering wheel, a lever, a button, a touchscreen, a keyboard, a gamepad, a mouse, a stylus, a wand, a gun, a knife, a handheld device, a wearable device, a biometric device, a computing device as described herein, and/or another device. In some embodiments, the user input device 108 may include one or more sensors for measuring movements, direction, intensity, acceleration, and/or the like of the user input device 108 as described herein. In some embodiments, the user input device 108 may be coupled to, included in, and/or otherwise incorporated into the gyroscopic chair 102.

In some embodiments, the user input device 108 may include various elements of a computing environment as described herein. For example, the user input device 108 may include a processing unit 136, a memory unit 138, an input/output (I/O) unit 140, and/or a communication unit 142. Each of the processing unit 136, the memory unit 138, the input/output (I/O) unit 140, and/or the communication unit 142 may include one or more subunits as described herein for performing operations associated with providing an enhanced virtual reality simulation experience as described herein.

The control server 110 may include a computing device for generating, receiving, transmitting, processing, rendering, modifying, transforming, and/or outputting audio content, video content, movement controls, sensor data, user inputs, and/or other information. In some embodiments, the control server 110 may include a handheld computing device, a smart phone, a tablet, a laptop computer, a desktop computer, a personal digital assistant (PDA), a smart watch, a wearable device, a biometric device, an implanted device, a camera, a video recorder, an audio recorder, a touchscreen, a content server, a mainframe server, a backend server, a touch screen, a video processing device, an audio processing device, and/or the like. In some embodiments, the control server 110 may include a plurality of servers configured to communicate with one another and/or implement load-balancing techniques or other processing allocation techniques described herein.

In some embodiments, the control server 110 may include various elements of a computing environment as described herein. For example, the control server 110 may include a processing unit 144, a memory unit 146, an input/output (I/O) unit 148, and/or a communication unit 150. Each of the processing unit 144, the memory unit 146, the input/output (I/O) unit 148, and/or the communication unit 150 may include one or more subunits as described herein for performing operations associated with providing an enhanced virtual reality simulation experience as described herein.

The gyroscopic chair 102, the head-mounted display 104, the acoustic feedback device 106, the user input device 108, and/or the control server 110 may be communicatively coupled to one another by a network 152 as described herein. In some embodiments, the network 152 may include a plurality of networks. In some embodiments, the network 152 may include any wireless and/or wired communications network that facilitates communication between the first user device 204, the second user device 208, and/or the control server 210. For example, the one or more networks 152 may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a laser-based network, and/or the like.

### Gyroscopic Chair Assembly

FIG. 2 shows an exemplary gyroscopic chair 200 as described herein. The gyroscopic chair 200 may be utilized by a user during operation of a virtual reality simulation experience to experience various physical forces and/or movements associated with actions performed by the user in the virtual reality simulation experience. In this manner, the gyroscopic chair 200 may provide the user with an enhanced virtual reality simulation experience.

The gyroscopic chair 200 may include a base 202 operatively coupled to the ground 204. The base 202 may support the weight and/or movements of the gyroscopic chair 200 during operation of a virtual reality simulation experience. In some embodiments, the base 202 may include a post, a pole, a box, a hydraulic arm, and/or another support structure. The base 202 and/or any other element of the gyroscopic chair 200 described herein may be formed from a rigid material such as steel, fiberglass, wood, aluminum, a metal alloy, and/or the like.

In some embodiments, the base 202 may include and/or may be operatively coupled to a motor 206 that enables movement of the base 202. For example, the motor 206 may enable rotation of the base 202 along a predetermined axis (e.g., a yaw axis). The motor 206 may further enable the base 202 (and therefore the entire gyroscopic chair 200) to be raised and/or lowered in elevation, to tilt, to roll, and/or move in another direction based on received inputs and/or sensor data as described herein. In some embodiments, the motor 206 may include one or more sensors and/or be controlled by one or more computing environments as described herein.

Additionally, the base 202 may be operatively coupled to a frame 208. Therefore, as the base 202 is rotated and/or otherwise moved by the motor 206, the frame 208 may rotate and/or otherwise move based on operation of the motor 206. The frame 208 may include one or more support beams 210. The support beams 210 may support a suspended ring 212 held between at least two support beams 210 as depicted in FIG. 2. The frame 208 may further include one or more motors 214 that enable rotation of the support beams 210 and thus the suspended ring 212 along a roll axis. The motors 214 may further enable the suspended ring 212 to be raised and/or lowered in elevation, to tilt, to roll, and/or move in another direction based on received inputs and/or sensor data as described herein. In some embodiments, the motors 214 may include one or more sensors and/or be controlled by one or more computing environments as described herein.

The suspended ring 212 may further be operatively coupled to a platform 216 via one or more platform supports 218. For example, the one or more platform supports 218 may be coupled to a track running along an inside surface of the suspended ring 212 so as to allow the platform 216 to rotate within the interior of the suspended ring 212 along a pitch axis. The suspended ring may also include one or more motors 220 that enable the platform 216 to move and/or rotate within the interior of the suspended ring 212 along the pitch axis. The motors 220 may further enable the platform 216 and/or the platform supports 218 to be raised and/or lowered in elevation, to tilt, to roll, and/or move in another direction based on received inputs and/or sensor data as described herein. In some embodiments, the motors 220 may include one or more sensors and/or be controlled by one or more computing environments as described herein.

The platform 216 may be configured to receive a user. For example, the platform 216 may include a chair, a seat, a harness, and/or another securing mechanism that enables the user to securely sit, stand, and/or lay down in the platform 216 during operation of the gyroscopic chair 200. In some embodiments, the platform 216 may include and/or may be operatively coupled to a user input device 222. For example, the user input device 222 may extend outwardly and/or upwardly from a portion of the platform 216 to provide easy user access to the user input device 222. As described herein, the user input device 222 may be utilized by the user during a virtual reality simulation experience (e.g., an interactive game) to provide inputs, control of direction, selections, and/or the like.

The gyroscopic chair 200 may further be integrated with a head-mounted display 224 and/or an acoustic feedback device 226. For example, one or more displays, speakers, subwoofers, and/or other input/output (I/O) devices described herein may be located at various positions throughout the gyroscopic chair 200 to provide the user with an immersive virtual reality simulation experience. In some embodiments, the head-mounted display 224 may be worn by a user of the gyroscopic chair 200 who is seated in the platform 216 of the gyroscopic chair 200. In some embodiments, the acoustic feedback device 226 may be included in and/or operatively coupled to the head-mounted display 224. Additionally and/or alternatively, the gyroscopic chair 200 may include haptic feedback devices such as additional motors, electromagnets, and/or other devices to vibrate the platform 216 during operation.

A control device 228 (e.g., a computing device, a control server as described herein, and/or the like) may be utilized to control movement of various elements of the gyroscopic chair 200, the head-mounted display 224, and/or the acoustic feedback device 226. For example, an interactive virtual reality simulation application running on the control device 228, the control device 228 may instruct one or more motors 206, 214, 220 of the gyroscopic chair 200 to move in one or more directions. This movement of the motors 206, 214, 220 may cause the platform 216 to move in a manner consistent with video content being transmitted by the control device 228 to the head-mounted display 224 and/or audio content being transmitted by the control device 228 to the acoustic feedback device 226. As such, the control device 228 may cause the user seated on the platform 216 to experience a variety of physical and/or physiological forces that correspond to movements and/or actions occurring in the virtual reality simulation environment such as acceleration, gravity, impacts, directional movements, and/or the like.

The control device 228 may also control movements of the user device 222, the head-mounted display 224, and/or the acoustic feedback device 226, as well as content provided to each of the user device 222, the head-mounted display 224, and/or the acoustic feedback device 226 during operation of a virtual reality simulation experience. In some embodiments, the control device 228 may control aspects of the gyroscopic chair 200, the user device 222, the head-mounted display 224, and/or the acoustic feedback device 226 based on received user input, sensor data, information received from a control server, information associated with a virtual reality simulation application, and/or the like.

Still further, the sensor data, including user emotions and/or perception data associated with the user and/or the user's movements can be received and utilized by the control device 228 to direct the actions of game or other application being used by the user. For example, the control device 228 may generate and/or provide to the user video content associated with a determined user movement. In this way, the user's perceptions, impressions, and/or emotions can further be used by the control device 228 to adapt the immersive user environment in response to identified user responses, movements, and/or emotions. As another example, the user may provide one or more movements such as a head tilt, a head turn, and/or the like to access various menus, make selections, and/or otherwise interact with video content (e.g., a game application) provided to the user by the control device 228 via the head-mounted display 224.

In this manner, controlling the motors 206, 214, 220 of the gyroscopic chair 200 using the control device 228 may cause the gyroscopic chair 200 to move in a variety of directions, thereby providing the user seated on the platform 216 with three degrees of freedom of movement (e.g., movement along a yaw axis, a roll axis, and/or a pitch axis). In some embodiments, movements of the gyroscopic chair 200 may occur around a center of gravity associated with the platform 216 so that all movements of the gyroscopic chair 200 are comfortable for the user. The motors 206, 214, 220 may further be controllable through position control loops operated by the control device 228, one or more computing devices, and/or one or more processors as described herein. As such, a wide variety of physical forces and/or physiological sensations associated with movements within the virtual reality environment may be created by the gyroscopic chair 200, and thus an enhanced and/or more realistic virtual reality simulation experience may be provided to the user.

### Computing Architecture

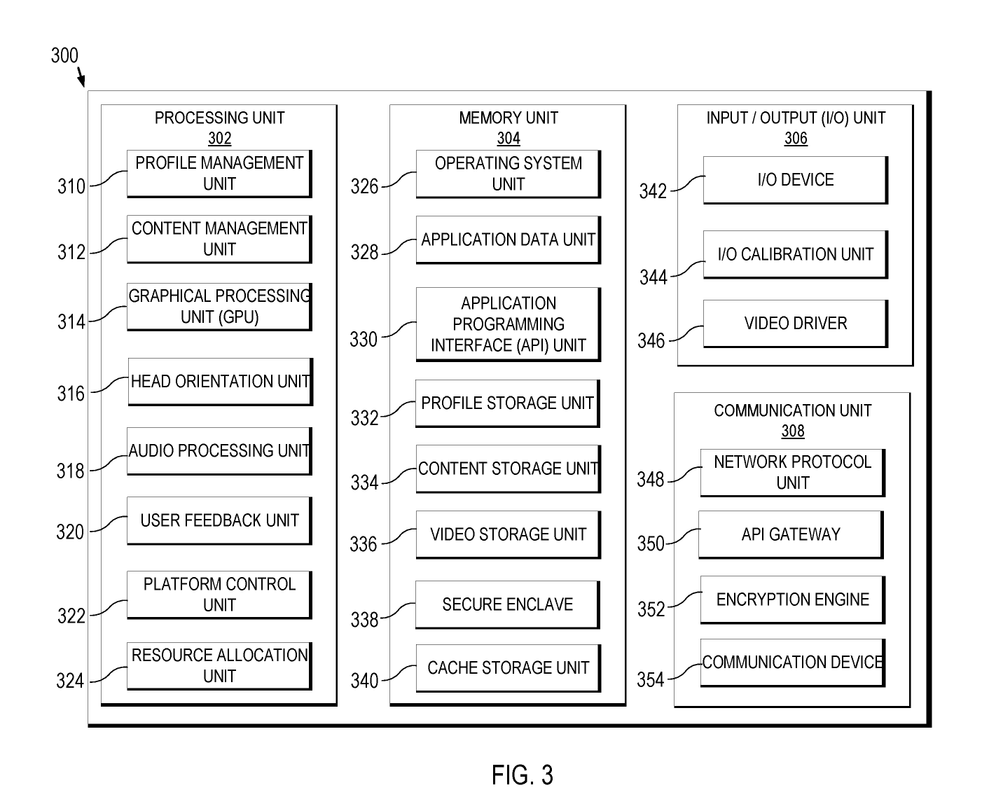

FIG. 3 illustrates an exemplary computing environment 300 for enabling the virtual reality simulation experience enhancement techniques described herein. For example, the computing environment 300 may support operation of an application such as an interactive game and/or another virtual reality simulation experience. In some embodiments, the computing environment 300 may be included in and/or utilized by the gyroscopic chair 102 of FIG. 1, the head-mounted display 104 of FIG. 1, the acoustic feedback device 106 of FIG. 1, the user input device 108 of FIG. 1, and/or the control server 110 of FIG. 1, the gyroscopic chair 200 of FIG. 2, and/or any other device described herein. Additionally, any units and/or subunits described herein with reference to FIG. 3 may be included in one or more elements of FIG. 1 such as the gyroscopic chair 102 (and/or the gyroscopic chair 200 of FIG. 2) (e.g., the processing unit 112, the memory unit 114, the I/O unit 116, and/or the communication unit 118), the head-mounted display 104 (e.g., the processing unit 120, the memory unit 122, the I/O unit 124, and/or the communication unit 126), the acoustic feedback device 106 (e.g., the processing unit 128, the memory unit 130, the I/O unit 132, and/or the communication unit 134), the user input device (e.g., the processing unit 136, the memory unit 138, the I/O unit 140, and/or the communication unit 142), and/or the control server 110 (e.g., the processing unit 144, the memory unit 146, the I/O unit 148, and/or the communication unit 150). The computing environment 300 and/or any of its units and/or subunits described herein may include general hardware, specifically-purposed hardware, and/or software.

The computing environment 300 may include, among other elements, a processing unit 302, a memory unit 304, an input/output (I/O) unit 306, and/or a communication unit 308. As described herein, each of the processing unit 302, the memory unit 304, the I/O unit 306, and/or the communication unit 308 may include and/or refer to a plurality of respective units, subunits, and/or elements. Furthermore, each of the processing unit 302, the memory unit 304, the I/O unit 306, and/or the communication unit 308 may be operatively and/or otherwise communicatively coupled with each other so as to facilitate the virtual reality simulation experience enhancement techniques described herein.

The processing unit 302 may control any of the one or more units 304, 306, 308, as well as any included subunits, elements, components, devices, and/or functions performed by the units 304, 306, 308 included in the computing environment 300. The processing unit 302 may also control any unit and/or device included in the system 100 of FIG. 1 and/or the gyroscopic chair of FIG. 2. Any actions described herein as being performed by a processor may be taken by the processing unit 302 alone and/or by the processing unit 302 in conjunction with one or more additional processors, units, subunits, elements, components, devices, and/or the like. Additionally, while only one processing unit 302 may be shown in FIG. 3, multiple processing units may be present and/or otherwise included in the computing environment 300. Thus, while instructions may be described as being executed by the processing unit 302 (and/or various subunits of the processing unit 302), the instructions may be executed simultaneously, serially, and/or by one or multiple processing units 302 in parallel.

In some embodiments, the processing unit 302 may be implemented as one or more computer processing unit (CPU) chips and/or graphical processing unit (GPU) chips and may include a hardware device capable of executing computer instructions. The processing unit 302 may execute instructions, codes, computer programs, and/or scripts. The instructions, codes, computer programs, and/or scripts may be received from and/or stored in the memory unit 304, the I/O unit 306, the communication unit 308, subunits and/or elements of the aforementioned units, other devices and/or computing environments, and/or the like. As described herein, any unit and/or subunit (e.g., element) of the computing environment 300 and/or any other computing environment may be utilized to perform any operation. Particularly, the computing environment 300 may not include a generic computing system, but instead may include a customized computing system designed to perform the various methods described herein.

In some embodiments, the processing unit 302 may include, among other elements, subunits such as a profile management unit 310, a content management unit 312, a graphical processing unit (GPU) 314, a head orientation unit 316, an audio processing unit 318, a user feedback unit 320, a platform control unit 322, and/or a resource allocation unit 324. Each of the aforementioned subunits of the processing unit 302 may be communicatively and/or otherwise operably coupled with each other.

The profile management unit 310 may facilitate generation, modification, analysis, transmission, and/or presentation of a user profile associated with a user. For example, the profile management unit 310 may prompt a user via a user device to register by inputting authentication credentials, personal information (e.g., an age, a gender, and/or the like), contact information (e.g., a phone number, a zip code, a mailing address, an email address, a name, and/or the like), and/or the like. The profile management unit 310 may also control and/or utilize an element of the I/O unit 306 to enable a user of the user device to take a picture of herself/himself. The profile management unit 310 may receive, process, analyze, organize, and/or otherwise transform any data received from the user and/or another computing element so as to generate a user profile of a user that includes personal information, contact information, user preferences, a photo, a video recording, an audio recording, a textual description, a virtual currency balance, a history of user activity, user preferences, settings, and/or the like.

The content management unit 312 may facilitate generation, modification, analysis, transmission, and/or presentation of media content. For example, the content management unit 312 may control the audio-visual environment and/or appearance of application data during execution of a virtual reality simulation experience. Media content for which the content management unit 312 may be responsible may include application data associated with a virtual reality simulator and/or a virtual reality simulation experience, advertisements, images, text, themes, audio files, video files, documents, and/or the like. In some embodiments, the content management unit 312 may also interface with a third-party content server and/or memory location to provide the user with content (e.g., audio content and/or visual content) during operation of a virtual reality simulation application such as an interactive game, a puzzle, a maze, a movie, a ride, and/or the like.

The GPU unit 314 may facilitate generation, modification, analysis, processing, transmission, and/or presentation of visual content (e.g., media content as described above). In some embodiments, the GPU unit 314 may be utilized to render visual content such as a virtual reality environment for presentation on the head-mounted display described herein. The GPU 314 may further process visual content and/or other content (e.g., video content and/or sensor data received from the head orientation unit 316 and/or the user feedback unit 320) in real time. The GPU unit 314 may also include multiple GPUs and therefore may be configured to perform and/or execute multiple processes in parallel.

The head orientation unit 316 may facilitate collection, recognition, processing, and/or analysis of sensor data associated with a user's body movements. For example, the head orientation unit 316 may collect sensor data associated with the user's head movements from one or more sensors (e.g., an accelerometer, a motion sensor, a gyroscope, and/or the like) included in the head-mounted display. In some embodiments, the head orientation unit 316 may identify head movements of the user such as a head tilt, a chin lift, a head turn, and/or the like. Additionally, the head orientation unit 316 may be utilized for collecting sensor data associated with the user's facial features. For example, the head orientation unit 316 may utilize a camera and/or a microphone included in the head-mounted display that is focused on the user's face to identify facial features, facial feature movements, facial gestures, vocal inflections, speech patterns, keywords, and/or the like.

The head orientation unit 316 may utilize a variety of audio-visual analysis techniques such as pixel comparison, pixel value identification, voice recognition, audio sampling, video sampling, image splicing, image reconstruction, video reconstruction, audio reconstruction, and/or the like to identify movements, gestures, and/or emotional cues of the user, to verify an identity of a user, and/or the like. As used herein, emotional cues may include facial gestures such as eyebrow movements, eyeball movements, eyelid movements, ear movements, nose and/or nostril movements, lip movements, chin movements, cheek movements, forehead movements, tongue movements, teeth movements, vocal pitch shifting, vocal tone shifting, changes in word delivery speed, keywords, word count, ambient noise and/or environment noise, background noise, and/or the like. In some embodiments, identified movements and/or facial gestures may be associated with an expressed emotion of the user such as happiness, sadness, excitement, anger, fear, anger, discomfort, joy, and/or envy, as well as other user characteristics such as gender, age, and/or the like. In some embodiments, the head orientation unit may identify, based on identified head and/or facial movements cues of the user, one or more emotions currently being experienced by the user, a desired action to be performed in the virtual reality simulation environment, and/or the like. For example, if the gesture analysis unit 320 may determine, based on identification of emotional cues associated with a frown (e.g., a furrowed brow, a frowning smile, flared nostrils, and/or the like), that a user is unhappy and would like a change of scenery in the virtual reality simulation environment.

In some embodiments, the head orientation unit 316 may additionally facilitate analysis and/or processing of identified movements (e.g., gestures, and/or emotions). For example, the head orientation unit 316 may quantify an identified movement by assigning a numerical value (e.g., an alphanumeric character) to the identified movement. In some embodiments, these numerical values may be weighted and/or assigned a grade (e.g., an alphanumeric label such as A, B, C, D, F, and/or the like) associated with a perceived value and/or quality (e.g., a desired movement or action, an emotion, and/or the like) by the head orientation unit 316. In addition to assigning numerical values of identified movements, the head orientation unit 316 may quantify and/or otherwise utilize other factors associated with a virtual reality simulation experience such as a time duration of the virtual reality simulation experience, an intensity, speed, and/or frequency of an identified movement, and/or the like. For example, the head orientation unit 316 may assign a larger weight to a first head tilt (perhaps associated with profound confusion) identified during a virtual reality simulation experience lasting ten seconds than a second head tilt (perhaps associated with mild confusion) identified during the virtual reality simulation experience lasting three seconds. The head orientation unit 316 may determine and/or assign appropriate numerical values based on a table of defined head movements, facial gestures associated with emotions, and/or a variety of factors associated with a virtual reality simulation experience such as a time duration, a frequency, an intensity, and/or the like.

The audio processing unit 318 may facilitate the collection, receipt, processing, analysis, distribution, and/or outputting of audio content associated with the virtual reality simulation experience. For example, the audio processing unit 318 may receive a surround sound audio signal from the content management unit 312, split the surround sound audio signal into multiple audio signals corresponding to a particular channel and/or speaker location in a surround sound speaker array associated with the gyroscopic chair and/or the head-mounted display, and transmit each audio signal to its corresponding speaker. Additionally, the audio processing unit 318 may maintain distribution of various channels of an audio signal to corresponding speakers (or other output devices) based on head movements of the user. For example, if the user is viewing a hovering helicopter in the middle of the head-mounted display, the audio associated with the helicopter's engines may be distributed in a centered fashion (e.g., so that the helicopter engine noise is equally loud in both left and right speakers). However, if the user turns his head ninety degrees to the right, then the audio associated with the helicopter's engines may be redistributed so that the helicopter engine noise is louder in the left speakers and quieter in the right speakers. In some embodiments, the audio processing unit 318 may be included in the head-mounted display, the user input device, and/or the gyroscopic chair. The audio processing unit 318 may also include one or more amplifiers and/or amplifying circuits, as well as a variety of circuits associated with audio processing and/or modulation techniques such as delay, reverb, compression, filtering, phase shifting, pitch shifting, and/or the like.

The user feedback unit 320 may facilitate the collection, receipt, processing, analysis, and/or transformation of user input received from a user input device. The user feedback unit 320 may enable the user to control various elements of the virtual reality simulation experience using a user input device. For example, the user may utilize a joystick, a keyboard, a controller, and/or the like communicatively coupled with the user feedback unit 320 to control an avatar or character (e.g., the user) and/or make selections in the virtual reality simulation experience. The user feedback unit 320 may collect and/or receive sensor data associated with movements and/or inputs of the user input device from one or more sensors (e.g., accelerometers, motion sensors, and/or the like) included in the user input device. In some embodiments, the user feedback unit 320 may be included in the user input device, the gyroscopic chair, the head-mounted display, and/or the control server as described herein.

The platform control unit 322 may facilitate control, operation, monitoring, adjusting, and/or programming one or more elements of a gyroscopic chair (e.g., gyroscopic chair 102 of FIG. 1 and/or gyroscopic chair 200 of FIG. 2). For example, the platform control unit 322 may utilize the numerical values of identified movements of the gyroscopic chair, user input device, head-mounted display, and/or acoustic feedback device, identified facial features, gestures, and/or emotions, as well as any received user input (e.g., user input provided by the user input device), to determine a corresponding action to be performed by the gyroscopic chair. In this manner, the platform control unit 322 may process received information (e.g., sensor data associated with movements, user inputs, and/or the like) to provide an enhanced virtual reality simulation experience. For example, received information may be utilized to control movements of the gyroscopic chair so that the gyroscopic chair responds to occurrences and/or inputs in the virtual reality simulation experience.

As an example, if the user is interacting with an application that enables a user to fly a virtual airplane from the perspective of a pilot in the airplane's cockpit, the platform control unit 322 may be responsible for moving elements of the gyroscopic chair in which the user sits in response to actions being performed in the virtual reality application. As the user moves a joystick (e.g., a user device) to steer the virtual airplane, the platform control unit 322 may control movements of the gyroscopic chair (e.g., elements of the gyroscopic chair) so that the user feels physical forces associated with movements of the virtual plane. For example, if the user pulls back on the joystick to cause the virtual airplane to climb altitude, the platform control unit 322 may cause the gyroscopic chair to lean backwards, thereby simulating a vertical climbing sensation and/or any gravitational forces associated with climbing altitude. Additionally, the platform control unit 322 may cause the gyroscopic chair to move in response to identified head movements of the user as he or she gazes outside of the virtual cockpit, any identified facial gestures and/or emotional cues, and/or the like.

In some embodiments, the platform control unit 322 may communicate with and/or otherwise utilize the content management unit 312, the content storage unit 344, and/or the I/O device 342 to control movement of the gyroscopic chair, to present various video and/or audio content to the user, and/or to perform other operations based on received sensor data and/or user inputs.

The resource allocation unit 324 may facilitate the determination, monitoring, analysis, and/or allocation of computing resources throughout the computing environment 300 and/or other computing environments. For example, the computing environment 300 may facilitate presentation of multiple streams of audio and/or video content to the acoustic feedback device and/or the head-mounted display, respectively. As such, computing resources of the computing environment 300 utilized by the processing unit 302, the memory unit 304, the I/O unit, and/or the communication unit 308 (and/or any subunit of the aforementioned units) such as processing power, data storage space, network bandwidth, and/or the like may be in high demand at various times during operation. Accordingly, the resource allocation unit 324 may be configured to manage the allocation of various computing resources as they are required by particular units and/or subunits of the computing environment 300 and/or other computing environments. In some embodiments, the resource allocation unit 324 may include sensors and/or other specially-purposed hardware for monitoring performance of each unit and/or subunit of the computing environment 300, as well as hardware for responding to the computing resource needs of each unit and/or subunit. In some embodiments, the resource allocation unit 324 may utilize computing resources of a second computing environment separate and distinct from the computing environment 300 to facilitate a desired operation.

For example, the resource allocation unit 324 may determine a number of simultaneously-operating virtual reality simulation experiences, a number of incoming requests for establishing virtual reality simulation experiences, a number of users to be connected to virtual reality simulation experiences, and/or the like. The resource allocation unit 324 may then determine that the number of simultaneous virtual reality simulation experiences and/or incoming requests for establishing virtual reality simulation experiences meets and/or exceeds an established threshold value. Based on this determination, the resource allocation unit 324 may determine an amount of additional computing resources (e.g., processing power, storage space of a particular non-transitory computer-readable memory medium, network bandwidth, and/or the like) required by the processing unit 302, the memory unit 304, the I/O unit 306, the communication unit 308, and/or any subunit of the aforementioned units for enabling safe and efficient operation of the computing environment 300. The resource allocation unit 324 may then retrieve, transmit, control, allocate, and/or otherwise distribute determined amount(s) of computing resources to each element (e.g., unit and/or subunit) of the computing environment 300 and/or another computing environment.

In some embodiments, factors affecting the allocation of computing resources by the resource allocation unit 324 may include a volume of virtual reality simulation experiences and/or other communication channel connections, a duration of time during which computing resources are required by one or more elements of the computing environment 300, and/or the like. In some embodiments, computing resources may be allocated to and/or distributed amongst a plurality of second computing environments included in the computing environment 300 based on one or more factors mentioned above. In some embodiments, the allocation of computing resources of the resource allocation unit 324 may include the resource allocation unit 324 flipping a switch, adjusting processing power, adjusting memory size, partitioning a memory element, transmitting data, controlling one or more input and/or output devices, modifying various communication protocols, and/or the like. In some embodiments, the resource allocation unit 324 may facilitate utilization of parallel processing techniques such as dedicating a plurality of GPUs included in the processing unit 302 for processing a high-quality video stream of a virtual reality simulation experience between multiple units and/or subunits of the computing environment 300 and/or other computing environments.

In some embodiments, the memory unit 304 may be utilized for storing, recalling, receiving, transmitting, and/or accessing various digital and/or analog files and/or information during operation of the computing environment 300. The memory unit 304 may include various types of data storage media such as solid state storage media, hard disk storage media, and/or the like. The memory unit 304 may include dedicated hardware elements such as hard drives and/or servers, as well as software elements such as cloud-based storage drives. For example, the memory unit 304 may include various subunits such as an operating system unit 326, an application data unit 328, an application programming interface (API) unit 330, a profile storage unit 332, a content storage unit 334, a video storage unit 336, a secure enclave 338, and/or a cache storage unit 340.

The memory unit 304 and/or any of its subunits described herein may include random access memory (RAM), read only memory (ROM), and/or various forms of secondary storage. RAM may be used to store volatile data and/or to store instructions that may be executed by the processing unit 302. For example, the data stored may be a command, a current operating state of the computing environment 300, an intended operating state of the computing environment 300, and/or the like. As a further example, data stored in the memory unit 304 may include instructions related to various methods and/or functionalities described herein. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may be comprised of one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory unit 304 may include one or more databases for storing any data described herein. Additionally or alternatively, one or more secondary databases located remotely from the computing environment 300 may be utilized and/or accessed by the memory unit 304.

The operating system unit 326 may facilitate deployment, storage, access, execution, and/or utilization of an operating system utilized by the computing environment 300 and/or any other computing environment described herein (e.g., a user device). In some embodiments, the operating system may include various hardware and/or software elements that serve as a structural framework for enabling the processing unit 302 to execute various operations described herein. The operating system unit 326 may further store various pieces of information and/or data associated with operation of the operating system and/or the computing environment 300 as a whole, such as a status of computing resources (e.g., processing power, memory availability, resource utilization, and/or the like), runtime information, modules to direct execution of operations described herein, user permissions, security credentials, and/or the like.

The application data unit 328 may facilitate deployment, storage, access, execution, and/or utilization of an application utilized by the computing environment 300 and/or any other computing environment described herein (e.g., a user device). In some embodiments, the application data unit 328 may store any information and/or data associated with a virtual reality simulation application such as an interactive game, movie, and/or the like. Information included in the application data unit 328 may enable a user to execute various operations described herein. The application data unit 328 may further store various pieces of information and/or data associated with operation of the application and/or the computing environment 300 as a whole, such as a status of computing resources (e.g., processing power, memory availability, resource utilization, and/or the like), runtime information, modules to direct execution of operations described herein, user permissions, security credentials, and/or the like.

The API unit 330 may facilitate deployment, storage, access, execution, and/or utilization of information associated with APIs of the computing environment 300 and/or any other computing environment described herein (e.g., a user device). For example, computing environment 300 may include one or more APIs for enabling various devices, applications, and/or computing environments to communicate with each other and/or utilize the same data. Accordingly, the API unit 330 may include API databases containing information that may be accessed and/or utilized by applications and/or operating systems of other devices and/or computing environments. In some embodiments, each API database may be associated with a customized physical circuit included in the memory unit 304 and/or the API unit 330. Additionally, each API database may be public and/or private, and so authentication credentials may be required to access information in an API database. In some embodiments, the API unit 330 may include a software development kit (SDK) for enabling other users to utilize various aspects of a virtual reality simulation application.

The profile storage unit 332 may facilitate deployment, storage, access, and/or utilization of information associated with user profiles of users by the computing environment 300 and/or any other computing environment described herein (e.g., a user device). For example, the profile storage unit 332 may store one or more user's contact information, authentication credentials, user preferences, user history of behavior, personal information, received input and/or sensor data, and/or metadata. In some embodiments, the profile storage unit 332 may communicate with the profile management unit 310 to receive and/or transmit information associated with a user's profile.

The content storage unit 334 may facilitate deployment, storage, access, and/or utilization of information associated with requested content by the computing environment 300 and/or any other computing environment described herein (e.g., a user device). For example, the content storage unit 334 may store one or more game files, applications, images, text, videos, audio content, advertisements, and/or metadata to be presented to a user during operations described herein. In some embodiments, the content storage unit 334 may communicate with the content management unit 312 to receive and/or transmit content files.

The video storage unit 336 may facilitate deployment, storage, access, analysis, and/or utilization of video content associated with the virtual reality simulation application by the computing environment 300 and/or any other computing environment described herein (e.g., a user device). For example, the video storage unit 336 may store one or more live video feeds of a user's gameplay displayed to the user via the head-mounted display, received user input and/or sensor data, and/or the like. Live video feeds of gameplay may be stored by the video storage unit 336 so that the live video feeds may be analyzed by various components of the computing environment 300 both in real time and at a time after receipt of the live video feeds. In some embodiments, the video storage unit 336 may communicate with the GPUs 314, the head orientation unit 316, the audio processing unit 318, the user feedback unit 320, and/or the platform control unit 322 to facilitate analysis of any stored video information. In some embodiments, video content may include audio, images, text, video feeds, and/or any other media content.

The secure enclave 338 may facilitate secure storage of data. In some embodiments, the secure enclave 338 may include a partitioned portion of storage media included in the memory unit 304 that is protected by various security measures. For example, the secure enclave 338 may be hardware secured. In other embodiments, the secure enclave 338 may include one or more firewalls, encryption mechanisms, and/or other security-based protocols. Authentication credentials of a user may be required prior to providing the user access to data stored within the secure enclave 338.

The cache storage unit 340 may facilitate short-term deployment, storage, access, analysis, and/or utilization of data. For example, the cache storage unit 348 may serve as a short-term storage location for data so that the data stored in the cache storage unit 348 may be accessed quickly. In some embodiments, the cache storage unit 340 may include RAM and/or other storage media types that enable quick recall of stored data. The cache storage unit 340 may included a partitioned portion of storage media included in the memory unit 304.

As described herein, the memory unit 304 and its associated elements may store any suitable information. Any aspect of the memory unit 304 may comprise any collection and arrangement of volatile and/or non-volatile components suitable for storing data. For example, the memory unit 304 may comprise random access memory (RAM) devices, read only memory (ROM) devices, magnetic storage devices, optical storage devices, and/or any other suitable data storage devices. In particular embodiments, the memory unit 304 may represent, in part, computer-readable storage media on which computer instructions and/or logic are encoded. The memory unit 304 may represent any number of memory components within, local to, and/or accessible by a processor (e.g., the processing unit 302).

The I/O unit 306 may include hardware and/or software elements for enabling the computing environment 300 to receive, transmit, and/or present information. For example, elements of the I/O unit 306 may be used to receive user input from a user via a user input device, present video content and/or virtual reality simulation application content to the user via the head-mounted display, present audio content to the user via the acoustic feedback device, control movement of the gyroscopic chair, and/or the like. In this manner, the I/O unit 306 may enable the computing environment 300 to interface with a human user. As described herein, the I/O unit 306 may include subunits such as an I/O device 342, an I/O calibration unit 344, and/or video driver 346.

The I/O device 342 may facilitate the receipt, transmission, processing, presentation, display, input, and/or output of information as a result of executed processes described herein. In some embodiments, the I/O device 342 may include a plurality of I/O devices. In some embodiments, the I/O device 342 may include one or more elements of a computing system, a control server, a sensor, an accelerometer, a head-mounted display, an acoustic feedback device, a gyroscopic chair, and/or a similar device.

The I/O device 342 may include a variety of elements that enable a user to interface with the computing environment 300. For example, the I/O device 342 may include the user input device such as a joystick, a controller, a wand, a keyboard, a touchscreen, a touchscreen sensor array, a mouse, a stylus, a button, a sensor, a depth sensor, a tactile input element, a location sensor, a biometric scanner, a laser, a microphone, a camera, a gamepad, and/or another element for receiving and/or collecting input from a user and/or information associated with the user and/or the user's environment. Additionally and/or alternatively, the I/O device 342 may include a head-mounted display, a screen, a projector, a sensor, a vibration mechanism, a light emitting diode (LED), a speaker, a radio frequency identification (RFID) scanner, and/or another element for presenting and/or otherwise outputting data to a user. In some embodiments, the I/O device 342 may communicate with one or more elements of the processing unit 302 and/or the memory unit 304 to execute operations described herein. For example, the I/O device 342 may include a display, which may utilize the GPU 314 to present audio content and/or video content stored in the video storage unit 336 to a user of a user device during a virtual reality simulation experience. The I/O device 342 may also enable the platform control unit 322 to control various elements of the gyroscopic chair during a virtual reality simulation experience.

The I/O calibration unit 344 may facilitate the calibration of the I/O device 342. In some embodiments, the I/O calibration unit 344 may detect and/or determine one or more settings of the I/O device 342, and then adjust and/or modify settings so that the I/O device 342 may operate more efficiently. For example, the I/O calibration unit 344 may identify an orientation and/or position of a user's head for establishment of a reference point from which all movements of the user's head may be measured. Similarly, the I/O calibration unit 344 may identify orientations and/or positions of the gyroscopic chair, the acoustic feedback device, the user input device, and/or the like.

In some embodiments, the I/O calibration unit 344 may utilize a video driver 346 (or multiple video drivers) to calibrate the I/O device 342. For example, the video driver 346 may be installed on a user device so that the user device may recognize and/or integrate with the I/O device 342, thereby enabling video content to be displayed, received, generated, and/or the like. In some embodiments, the I/O device 342 may be calibrated by the I/O calibration unit 344 by based on information included in the video driver 346. In this manner, the video driver may enable video content associated with the virtual reality simulation experience to be displayed appropriately to the user via the head-mounted display.

The communication unit 308 may facilitate establishment, maintenance, monitoring, and/or termination of communication connections between the computing environment 300 and other devices such as the control server, the gyroscopic chair, the head-mounted display, the acoustic feedback device, the user input device, other computing environments, third party server systems, and/or the like. The communication unit 308 may further enable communication between various elements (e.g., units and/or subunits) of the computing environment 300. In some embodiments, the communication unit 308 may include a network protocol unit 348, an API gateway 350, an encryption engine 352, and/or a communication device 354. The communication unit 308 may include hardware and/or software elements. In some embodiments, the communication unit 308 may be utilized to transmit and/or receive audio and/or video content associated with the virtual reality simulation experience.

The network protocol unit 348 may facilitate establishment, maintenance, and/or termination of a communication connection between the computing environment 300 and another device by way of a network. For example, the network protocol unit 348 may detect and/or define a communication protocol required by a particular network and/or network type. Communication protocols utilized by the network protocol unit 348 may include Wi-Fi protocols, Li-Fi protocols, cellular data network protocols, Bluetooth® protocols, WiMAX protocols, Ethernet protocols, powerline communication (PLC) protocols, Voice over Internet Protocol (VoIP), and/or the like. In some embodiments, facilitation of communication between the computing environment 300 and any other device, as well as any element internal to the computing environment 300, may include transforming and/or translating data from being compatible with a first communication protocol to being compatible with a second communication protocol. In some embodiments, the network protocol unit 348 may determine and/or monitor an amount of data traffic to consequently determine which particular network protocol is to be used for operating a virtual reality simulation experience, transmitting data, and/or performing other operations described herein.

The API gateway 350 may facilitate the enablement of other devices and/or computing environments to access the API unit 330 of the memory unit 304 of the computing environment 300. For example, a user device may access the API unit 330 via the API gateway 350. In some embodiments, the API gateway 350 may be required to validate user credentials associated with a user of a user device prior to providing access to the API unit 330 to the user. The API gateway 350 may include instructions for enabling the computing environment 300 to communicate with another device.

The encryption engine 352 may facilitate translation, encryption, encoding, decryption, and/or decoding of information received, transmitted, and/or stored by the computing environment 300. Using the encryption engine, each transmission of data may be encrypted, encoded, and/or translated for security reasons, and any received data may be encrypted, encoded, and/or translated prior to its processing and/or storage. In some embodiments, the encryption engine 352 may generate an encryption key, an encoding key, a translation key, and/or the like, which may be transmitted along with any data content.

The communication device 354 may include a variety of hardware and/or software specifically purposed to enable communication between the computing environment 300 and another device, as well as communication between elements of the computing environment 300. In some embodiments, the communication device 354 may include one or more radio transceivers, chips, analog front end (AFE) units, antennas, processing units, memory, other logic, and/or other components to implement communication protocols (wired or wireless) and related functionality for facilitating communication between the computing environment 300 and any other device. Additionally and/or alternatively, the communication device 354 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

It is contemplated that the computing elements be provided according to the structures disclosed herein may be included in integrated circuits of any type to which their use commends them, such as ROMs, RAM (random access memory) such as DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as digital signal processors (DSP), graphics system processors (GSP), synchronous vector processors (SVP), and image system processors (ISP) all represent sites of application of the principles and structures disclosed herein.

Implementation is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

Networked computing environment such as those provided by a communications server may include, but are not limited to, computing grid systems, distributed computing environments, cloud computing environment, etc. Such networked computing environments include hardware and software infrastructures configured to form a virtual organization comprised of multiple resources which may be in geographically disperse locations.

### System Operation

To begin operation of embodiments described herein, a user may first be received by platform of the gyroscopic chair. For example, the user may sit in a seat included in the platform of the gyroscopic chair. In some embodiments, the platform may include one or more sensors (e.g., visual sensors, weight sensors, and/or the like) to detect the presence of the user.

Once the user is received by the platform of the gyroscopic chair, the user may utilize the head-mounted display. For example, the head-mounted display may include an opening into which the user may insert her or his head. In this manner, the head-mounted display may be worn on the head of the user during operation.

The user may then initiate and/or download a virtual reality simulation application associated with operations described herein. For example, the user may download a virtual flight simulation application from an application store and/or a digital library of applications available for download via an online network. In some embodiments, downloading the virtual reality simulation application may include transmitting application data from the application data unit 328 of the computing environment 300 to the head-mounted display, the acoustic feedback device, and/or the gyroscopic chair.

Upon download and/or initiation of the application, the user may select and open the application using the user input device. In some embodiments, the application may then prompt the user via the head-mounted display to register and create a user profile using the user input device. The user may use the user input device to input authentication credentials such as a username and password, an email address, contact information, personal information (e.g., an age, a gender, and/or the like), user preferences, and/or other information as part of the user registration process. This inputted information, as well as any other information described herein, may be inputted by the user and/or outputted to the user using the I/O device 342 (e.g., the head-mounted display, the user input device, the acoustic feedback device, and/or the like). Once inputted, the information may be received by the profile management unit 310 and/or the profile storage unit 332, which may be configured to receive the inputted information.

In some embodiments, registration of the user may include generating and/or transmitting to the user a confirmation message requesting the user to confirm registration and/or any inputted information to be included in the user profile from the profile management unit 310. The user may confirm registration via the user input device, and an acknowledgement may be transmitted to the profile management unit 310, which receives the acknowledgement and generates a user profile based on the inputted information.

After registration is complete, the user may utilize the I/O device 342 (e.g., a camera included in the head-mounted display) to capture an picture of the her or his face. This picture, once generated, may be included in the user profile of the user for identification of the user. The user may further be enabled to modify the image by applying a filter, cropping the image, changing the color and/or size of the image, and/or the like using the user device. Accordingly, the image may be transmitted to the computing environment 300 for processing. Alternatively, the image may be processed locally on the head-mounting display.

In some embodiments, the image may be received and analyzed (e.g., processed) by the profile management unit 310 and/or the head orientation unit 316. In some embodiments, the profile management unit 310 and/or the head orientation unit 316 may utilize the GPU 314 for analysis of the image. The profile management unit 310 and/or the head orientation unit 316 may process the image of the user's face to identify human facial features. Various techniques may be deployed during processing of the image to identify facial features, such as pixel color value comparison. For example, the profile management unit 310 and/or the head orientation unit 316 may identify objects of interest and/or emotional cues in the image based on a comparison of pixel color values and/or locations in the image. Each identified object of interest may be counted and compared to known facial features included in a database using the profile management unit 310 and/or the head orientation unit 316. The profile management unit 310 and/or the head orientation unit 316 may determine at least a partial match (e.g., a partial match that meets and/or exceeds a determined threshold of confidence) between an identified object of interest and a known facial feature to thereby confirm that the object of interest in the image is indeed a facial feature of the user. Based on a number and/or a location of identified facial features in the image, the profile management unit 310 and/or the head orientation unit 316 may determine that the image is a picture of the user's face (as opposed to other subject matter, inappropriate subject matter, and/or the like). In this manner, the profile management unit 310 and/or the head orientation unit 316 may provide a layer of security by ensuring that the image included in a user's profile is a picture of the user's face.

Once the profile management unit 310 and/or the head orientation unit 316 determines that the image is an acceptable picture of the user's face, the computing environment 300 may store the image in the profile storage unit 332 so that the image may be included in the user's user profile. Conversely, when the profile management unit 310 and/or the head orientation unit 316 determines that the image is not an acceptable picture of the user's face (e.g., due to poor picture quality), the profile management unit 310 and/or the head orientation unit 316 may generate a notification to be sent to and/or displayed by the user device for presentation to the user that explains that the provided image is unacceptable. The user may then repeat the process of capturing an image of her or his face using the head-mounted display. In some embodiments, the user may be prohibited by the computing environment 300 from continuing application use until an image of the user's face is determined by the profile management unit 310 and/or the head orientation unit 316 to be legitimate.

As stated above, the image may be processed by the profile management unit 310 and/or the head orientation unit 316 on the user device. In other embodiments, the image may be transmitted to another device (e.g., computing environment 300, a third party backend server, and/or the like) for processing. In some embodiments, any facial features of the user identified by the profile management unit 310 and/or the head orientation unit 316 may be stored in the profile storage unit 332 for later recall during analysis of video content of the user.

After registration and generation of the user's profile is complete (if required), the user may initiate, using the user input device, a request to begin a virtual reality simulation such as an interactive gaming session. After initiation, the request may be transmitted to and/or received by the communication unit 308 of the computing environment 300.

The I/O calibration unit 344 may calibrate the gyroscopic chair, the user input device, the head-mounted display, and/or the acoustic feedback device to ensure all movements of each of the gyroscopic chair, the user input device, the head-mounted display, and/or the acoustic feedback device accurately correspond to movements and/or happenings in the virtual environment. In some embodiments, the I/O calibration unit 344 may receive sensor data from the gyroscopic chair, the user input device, the head-mounted display, and/or the acoustic feedback device. The I/O calibration unit 344 may determine, based on an analysis of the received sensor data, one or more reference points associated with each of the gyroscopic chair, the user input device, the head-mounted display, and/or the acoustic feedback device. In this manner, the I/O calibration unit 344 may identify references points from which movements of each of the gyroscopic chair, the user input device, the head-mounted display, and/or the acoustic feedback device may be measured. The I/O calibration unit 344 may also determine, based on an analysis of sensor data, an orientation and/or a position of each of the gyroscopic chair, the user input device, the head-mounted display, and/or the acoustic feedback device and/or their elements.

Once calibration of the gyroscopic chair, the user input device, the head-mounted display, and/or the acoustic feedback device have been successfully calibrated by the I/O calibration unit 344, the content management unit 312 may then provide the head-mounted display with video content (e.g., video data) for viewing by the user. For example, the content management unit 312 may provide the head-mounted display with a virtual environment associated with a virtual reality simulation application and/or provide the acoustic feedback device with one or more audio signals associated with the virtual reality simulation application.

As the user views the video content and listens to the audio content associated with the virtual reality simulation application, the platform control unit 322 may provide movement data to the gyroscopic chair so that the gyroscopic chair moves in response to various elements provided to the user in the virtual reality simulation environment. For example, if the user controls an avatar in the virtual environment to jump off of a ledge in the virtual environment, then the platform control unit 322 may transmit movement data to one or more motors of the gyroscopic chair to cause the motors to move one or more elements of the gyroscopic chair in efforts of simulating a physiological feeling of falling. As such, the movement data may cause the platform (and thus the user) to tilt downwards.

Further, the user may be enabled to interact with and/or respond to the virtual reality environment in a variety of ways. For example, the user may move (e.g., rotate, tilt, raise, lower, and/or the like) her or his head in response to various elements provided to the user in the virtual reality simulation environment. In some embodiments, head movements of the user may cause a corresponding change in view and/or video data provided to the user via the head-mounted display. For example, if the user rotates her head to the left, then the viewpoint provided to the user via the head-mounted display may shift to the left. In some embodiments, user movements, such as a head tilt, may generate sensor data, which may be utilized by the computing environment 300 to determine video content (e.g., game application data) to be presented to the user. For example, based on a head tilt, a door in the virtual reality simulation experience may open, and an avatar of an enemy character my be generated and presented to the user via the head-mounted display. Sensor data may also be utilized by the computing environment 300 to determine one or more actions to be performed by motors of the gyroscopic chair. For example, based on a head tilt, the control device and/or control server described herein may cause the platform of the gyroscopic chair (and thus the user) to tilt in a direction that corresponds to the head tilt. In this manner, sensor data associated with user responses (e.g., emotions, movements, and/or the like) may be utilized to provide the user with an enhanced virtual reality simulation experience.

Additionally and/or alternatively, the user may move facial features or speak (e.g., provide verbal input) in response to various elements provided to the user in the virtual reality simulation environment. A camera, a microphone, sensors, and/or another input device 342 may be utilized to capture various facial movements, gestures, and/or speech of the user during the virtual reality simulation experience. Identified facial movements, gestures, and/or speech may enable the user to interact with various elements in the virtual environment as described herein.

Additionally and/or alternatively, the user may interact with the user input device (e.g., move a joystick, pull a trigger, push a button, and/or the like) in response to various elements provided to the user in the virtual reality simulation environment. In this manner, the user may control movement of an avatar and/or operation of an object (e.g., a vehicle) in the virtual reality simulation environment using the user input device. For example, the user may, using the user input device, control a walking movement of a person in the virtual environment, drive and/or fly a vehicle, and/or perform various other actions.

Each of these movements performed by the user in response to various elements provided to the user in the virtual reality simulation environment may generate sensor data. Once generated, the sensor data may be transmitted from each of the head-mounted display, the acoustic feedback device, and/or the user input device to the computing environment 300. For example, sensor data associated with head movements, facial movements, gestures, and/or speech may be transmitted from the head-mounted display to the head orientation unit 316 and/or the audio processing unit 318. Sensor data associated with provided user inputs may be transmitted from the user input device to the user feedback unit 320. Each of the head orientation unit 316, the audio processing unit 318, and/or the user feedback unit 320 may process received sensor data individually. Alternatively, sensor data may be aggregated by the platform control unit 322 for processing.

The platform control unit 322 may process sensor data received from each element, motor, and/or device described herein to determine one or more movements that are to be performed by the gyroscopic chair to provide the user with a realistic virtual reality simulation experience. For example, the platform control unit 322 may determine to cause the gyroscopic chair to move in one or more directions based on a provided user input, a head movement, an identified spoken key word, an identified facial gesture associated with an emotion, and/or the like. Further, the platform control unit 322 may further process sensor data in conjunction with video content associated with the virtual reality simulation experience so as to ensure that the received sensor data is indeed relevant to the video content being provided to the user via the head-mounted display.

Based on this processing of sensor data, the platform control unit 322 may provide instructions to one or more motors included in the gyroscopic chair to perform one or more operations. For example, based on a sharp head turn to the right and a hard push to the right of the joystick (e.g., the user is a pilot of an airplane and wishes to bank and turn to the right), the platform control unit 322 may instruct one or more motors to tilt, rotate, extend, lower, raise, and/or the like so that the gyroscopic chair moves in such a way as to provide a physical sensation of riding in an airplane that is banking to the right. In some embodiments, various elements of the gyroscopic chair may move along one or more orientation vectors (e.g., movement vectors, and/or the like) determined by the platform control unit 322 to be necessary for providing the user with a desired sensation. In this manner, elements of the gyroscopic chair may perform a variety movements based on motor functions controlled by the platform control unit 322 to provide the user with a more realistic virtual reality simulation experience than simply wearing the head-mounted display alone.

Additionally, a live video feed (e.g., sensor data) of the user's face may be transmitted to and/or received by the computing environment 300 for processing. For example, the GPU 314 may be utilized by the head orientation unit 316 for determining which, if any, emotions are being expressed by the user.

Similar to the facial feature recognition processes outlined above, the GPU 314 and/or the head orientation unit 316 may analyze a live video feed and/or a live audio feed of the user using a variety of video and/or audio analysis techniques. For example, the facial/vocal recognition unit 318 may employ various pixel comparison techniques described herein to identify facial features in the live video feeds of each user to determine various emotions and/or gestures expressed by the user during the virtual reality simulation experience.

Additionally, the head orientation unit 316 may analyze any captured audio of the user. An analysis of captured audio may utilize vocal recognition techniques to identify keywords, changes in vocal pitch and/or vocal tone, and/or other objects of interest (e.g., emotional cues). Particularly, identifying objects of interest such as changes in vocal pitch and/or vocal tone or keywords in a user's speech in this manner may enable the head orientation unit 316 to determine whether that user is laughing, crying, yelling, screaming, using sarcasm, and/or is otherwise displaying a particular emotion (e.g., a positive emotion and/or a negative emotion).

Accordingly, any emotional cues identified by the head orientation unit 316 (e.g., facial features, gestures, emotions, speech patterns, key words, and/or the like) may be identified based on an amount of movement of one or more facial features based on pixel locations of identified facial features, a change in color of one or more facial features, a change in vocal inflection, vocal pitch, vocal phrasing, rate of speech delivery, and/or vocal tone, and/or the like. For example, based on determining that both corners of the user's lips moved upwards in relation to other identified facial features, the head orientation unit 316 may determine that the user is smiling and thus experiencing a positive emotion. The platform control unit 322 may determine one or more movements to be performed by one or more motors based on an emotion, facial feature, facial gesture, spoke word, keywords, speech patterns, and/or the like identified from received sensor data.

In some embodiments, the platform control unit 322 may determine orientation vectors, movement vectors, and/or the like based on received sensor data and/or reference points of the head-mounted display, the user input device, the acoustic feedback device, and/or other elements of the gyroscopic chair determined during configuration processes described herein. For example, the platform control unit 322 may determine a distance, a speed, a duration, and/or other factors associated with a particular movement to be performed by each element of the gyroscopic chair to achieve a desired physical and/or physiological sensation for the user. This information may be included in the instructions transmitted from the platform control unit 322 to the one or more motors of the gyroscopic chair. After a desired movement has been performed by the one or more motors, the platform control unit 322 may instruct elements of the gyroscopic chair to return to corresponding original reference points.

### Method Descriptions

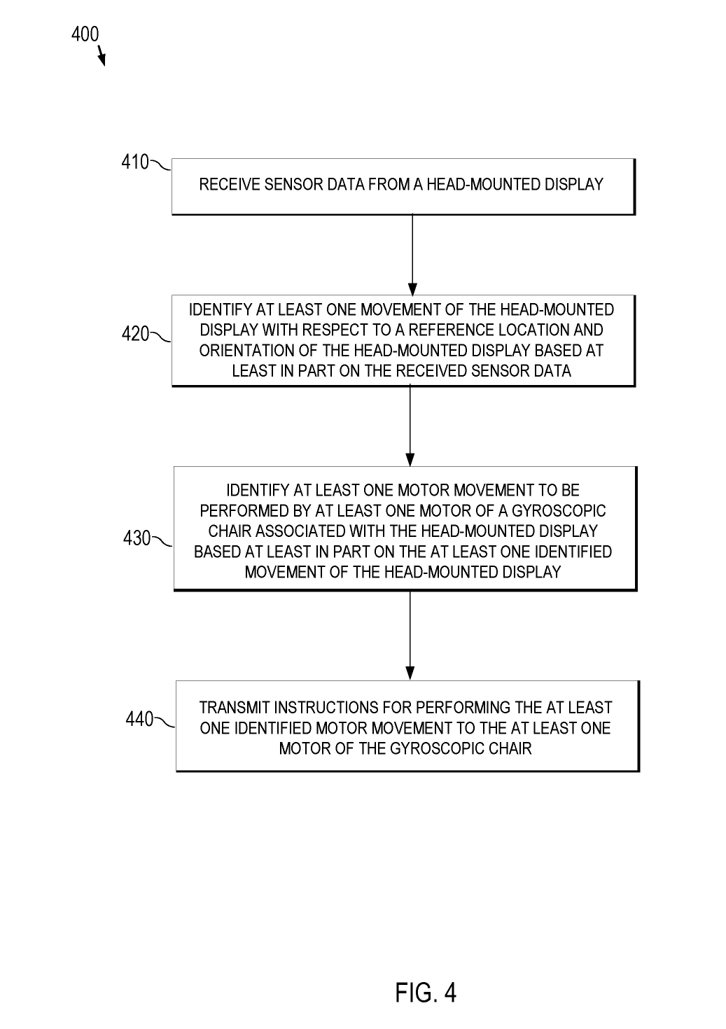

FIG. 4 shows an exemplary method 400 for performing operations associated with controlling motor movement of a gyroscopic chair based on a detected head movement as described herein. At block 410, the method 400 may include receiving sensor data from a head-mounted display. At block 420, the method 400 may include identifying at least one movement of the head-mounted display with respect to a reference location and orientation of the head-mounted display based at least in part on the received sensor data. At block 430, the method 400 may include identifying at least one motor movement to be performed by at least one motor of a gyroscopic chair associated with the head-mounted display based at least in part on the at least one identified movement of the head-mounted display. At block 440, the method 400 may include transmitting instructions for performing the at least one identified motor movement to the at least one motor of the gyroscopic chair.

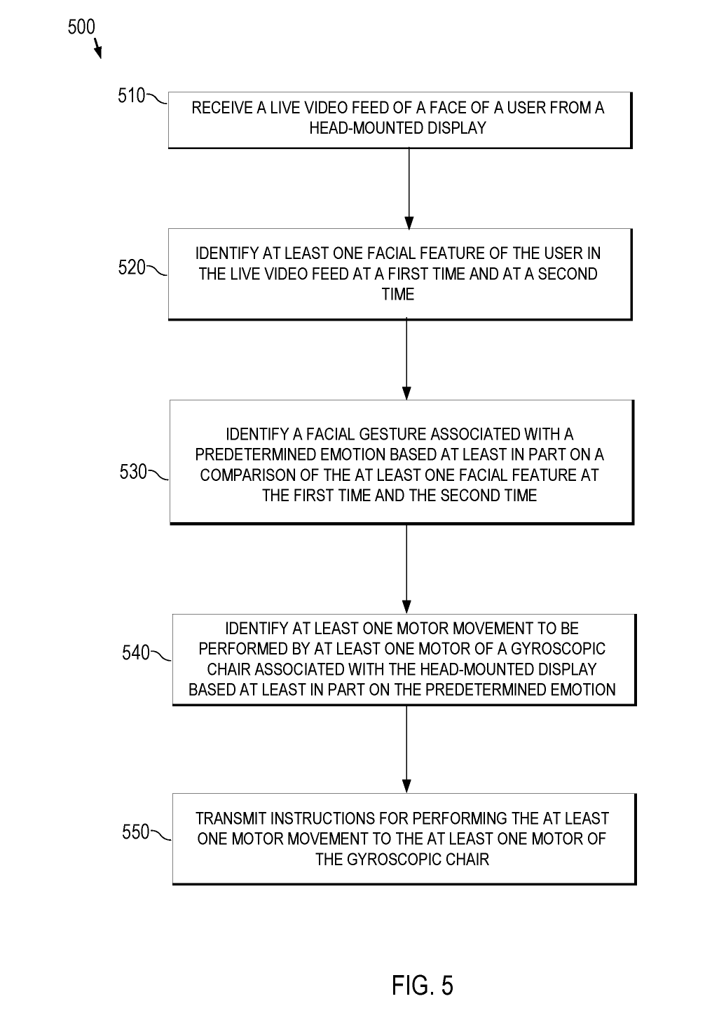

FIG. 5 shows an exemplary method 500 for performing operations associated with controlling motor movement of a gyroscopic chair based on a detected emotion of a user as described herein. At block 510, the method 500 may include receiving a live video feed of a face of a user from a head-mounted display. At block 520, the method 500 may include identifying at least one facial feature of the user in the live video feed at a first time and a second time. At block 530, the method 500 may include identifying a facial gesture associated with a determined emotion based at least in part on a comparison of the at least one facial feature at the first time and the second time. At block 540, the method 500 may include identifying at least one motor movement to be performed by at least one motor of a gyroscopic chair associated with the head-mounted display based at least in part on the determined emotion. At block 550, the method 500 may include transmitting instructions for performing the at least one motor movement to the at least one motor of the gyroscopic chair.

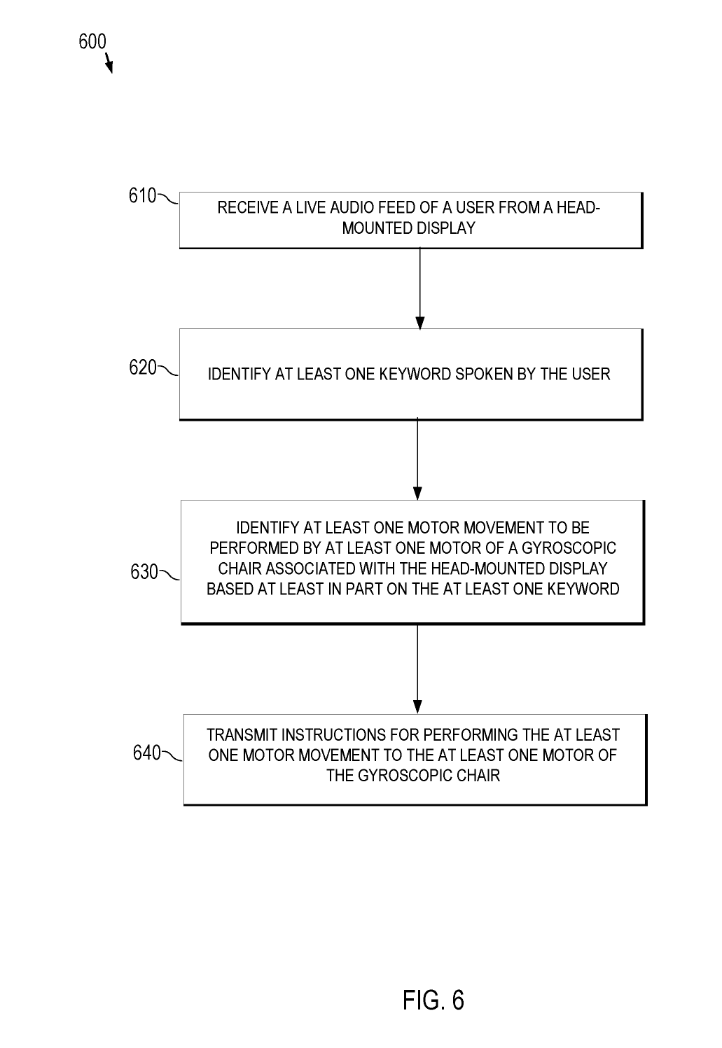

FIG. 6 shows an exemplary method 600 for performing operations associated with controlling motor movement of a gyroscopic chair based on a spoken keyword as described herein. At block 610, the method 600 may include receiving a live audio feed of a user from a head-mounted display. At block 620, the method 600 may identifying at least one keyword spoken by the user. At block 630, the method 600 may include identifying at least one motor movement to be performed by at least one motor of a gyroscopic chair associated with the head-mounted display based at least in part on the at least one keyword. At block 640, the method 600 may include transmitting instructions for performing the at least one motor movement to the at least one motor of the gyroscopic chair.

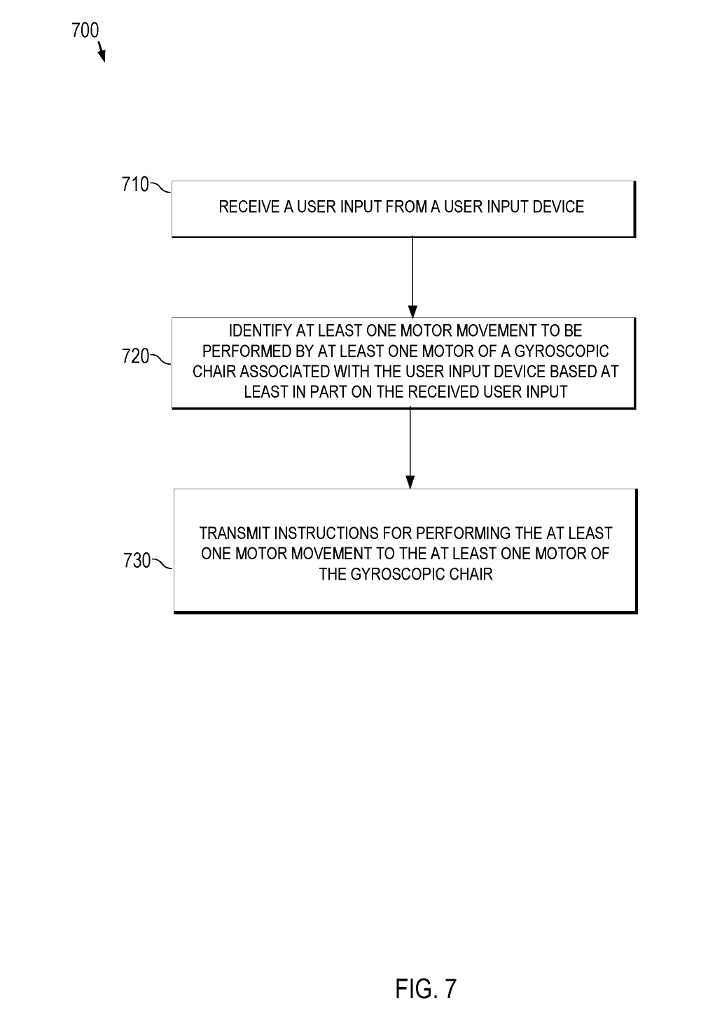

FIG. 7 shows an exemplary method 700 for performing operations associated with controlling motor movement of a gyroscopic chair based on a received user input as described herein. At block 710, the method 700 may include receiving a user input from a user input device. At block 720, the method 700 may include identifying at least one motor movement to be performed by at least one motor of a gyroscopic chair associated with the user input device based at least in part on the received user input. At block 730, the method 700 may transmitting instructions for performing the at least one motor movement to the at least one motor of the gyroscopic chair.

### Disclaimers

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

Lastly, although similar reference numbers may be used to refer to similar elements for convenience, it can be appreciated that each of the various example implementations may be considered distinct variations.

What is claimed is:

1. A gyroscopic chair comprising:
a frame;
a suspended ring coupled to the frame;
a platform coupled to the suspended ring and configured to receive a user; and
at least one motor coupled to at least one of the frame, the suspended ring, and the platform, wherein the at least one motor is configured to control movement of at least one of the frame, the suspended ring, and the platform.

2. The gyroscopic chair of claim 1, wherein the frame is coupled to a base, and wherein the at least one motor is configured to rotate the frame on a yaw axis with respect to the platform.

3. The gyroscopic chair of claim 1, wherein the at least one motor is configured to rotate the suspended ring on a roll axis with respect to the platform.

4. The gyroscopic chair of claim 1, wherein the at least one motor is configured to rotate the platform on a pitch axis with respect to the suspended ring.

5. The gyroscopic chair of claim 1, wherein the at least one motor is configured to control movement of at least one of the frame, the suspended ring, and the platform based on movement data received from a control server associated with a virtual reality simulation application.

6. The gyroscopic chair of claim 5, wherein the movement data is generated by the control server based at least in part on video content associated with the virtual reality simulation application and sensor data received from at least one of a head-mounted display, an acoustic feedback device, and a user input device.

7. The gyroscopic chair of claim 6, wherein the sensor data is associated with at least one of a head movement, a facial gesture, a spoken keyword, a vocal inflection, and a user input.

8. A video communication sever, comprising:
at least one memory comprising instructions; and
at least one processing device configured for executing the instructions, wherein the instructions cause the at least one processing device to perform the operations of:
receiving, using a content management unit comprised in the at least one processing device, video content associated with a virtual reality simulation application;
receiving, using at least one of a head orientation unit comprised in the at least one processing device, an audio processing unit comprised in the at least one processing device, and a user feedback unit comprised in the at least one processing device sensor data from at least one of a head-mounted display, an acoustic feedback device, and a user input device;
identifying, using a platform control unit comprised in the at least one processing device, movement data associated with at least one motor movement to be performed by at least one motor of the gyroscopic chair based at least in part on the video content and the received sensor data;
transmitting, using the platform control unit, the movement data to the at least one motor of the gyroscopic chair.

9. The control server of claim 8, wherein transmitting the movement data to the at least one motor of the gyroscopic chair causes the at least one motor to perform at least one movement, wherein performing the at least one movement causes at least one element of the gyroscopic chair to move.

10. The control server of claim 9, wherein the at least one element of the gyroscopic chair comprises at least one of a frame, a suspended ring, and a platform configured to receive a user.

11. The control server of claim 8, wherein the sensor data is associated with at least one of a head movement, a facial gesture, a spoken keyword, a vocal inflection, a vocal pitch shift, a change in word delivery speed, and a user input.

12. The control server of claim 11, wherein the head movement is identified by:
receiving, from the head-mounted display and using the head orientation unit, sensor data associated with the head-mounted display;
identifying, using the head orientation unit, a first location and a first orientation of the head-mounted display at a first time;
identifying, using the head orientation unit, a second location and a second orientation of the head-mounted display a second time; and
identifying the head movement based at least in part on a comparison between the identified location and orientation of the head-mounted display at the first time and the identified location and orientation of the head-mounted display at the second time.

13. The control server of claim 11, wherein the facial gesture is identified by:
receiving, from the head-mounted display and using the head orientation unit, a live video feed of a face of a user of the head-mounted display;
identifying, in the live video feed and using the head orientation unit, a first location of at least one facial feature of a user of the head-mounted display at a first time;
identifying, in the live video feed and using the head orientation unit, a second location of the at least one facial feature of the user at a second time; and
determining, using the head orientation unit, movement of the facial feature from the first location at a first time to the second location at a second time, wherein the determined movement of the facial feature comprises the facial gesture, and wherein the facial gesture is associated with a determined emotion.

14. The control server of claim 11, wherein the vocal inflection is identified by:
receiving, from the head-mounted display and using the audio processing unit, a live audio feed of speech of a user of the head-mounted display;
identifying, in the live audio feed and using the audio processing unit, a first vocal pitch of speech of the user at a first time;
identifying, in the live audio feed and using the audio processing unit, a second vocal pitch of speech of the user at a second time; and
determining, using the audio processing unit, a change of vocal pitch of speech of the first user, wherein the determined change of vocal pitch is associated with a determined emotion.

15. A method comprising:
receiving, using a content management unit comprised in at least one processing device, video content associated with a virtual reality simulation application;
receiving, using at least one of a head orientation unit comprised in the at least one processing device, an audio processing unit comprised in the at least one processing device, and a user feedback unit comprised in the at least one processing device sensor data from at least one of a head-mounted display, an acoustic feedback device, and a user input device;
identifying, using a platform control unit comprised in the at least one processing device, movement data associated with at least one motor movement to be performed by at least one motor of the gyroscopic chair based at least in part on the video content and the received sensor data;
transmitting, using the platform control unit, the movement data to the at least one motor of the gyroscopic chair.

16. The method of claim 15, wherein transmitting the movement data to the at least one motor of the gyroscopic chair causes the at least one motor to perform at least one movement, wherein performing the at least one movement causes at least one element of the gyroscopic chair to move.

17. The method of claim 16, wherein the at least one element of the gyroscopic chair comprises at least one of a frame, a suspended ring, and a platform configured to receive a user.

18. The method of claim 15, wherein the sensor data is associated with at least one of a head movement, a facial gesture, a spoken keyword, a vocal inflection, a vocal pitch shift, a change in word delivery speed, and a user input.

19. The method of claim 18, wherein the head movement is identified by:
receiving, from the head-mounted display and using the head orientation unit, sensor data associated with the head-mounted display;
identifying, using the head orientation unit, a first location and a first orientation of the head-mounted display at a first time;
identifying, using the head orientation unit, a second location and a second orientation of the head-mounted display a second time; and
identifying the head movement based at least in part on a comparison between the identified location and orientation of the head-mounted display at the first time and the identified location and orientation of the head-mounted display at the second time.

20. The method of claim 15, wherein the facial gesture is identified by:
receiving, from the head-mounted display and using the head orientation unit, a live video feed of a face of a user of the head-mounted display;
identifying, in the live video feed and using the head orientation unit, a first location of at least one facial feature of a user of the head-mounted display at a first time;
identifying, in the live video feed and using the head orientation unit, a second location of the at least one facial feature of the user at a second time; and
determining, using the head orientation unit, movement of the facial feature from the first location at a first time to the second location at a second time, wherein the determined movement of the facial feature comprises the facial gesture, and wherein the facial gesture is associated with a determined emotion.
